(19) United States
(12) Patent Application Publication
(10) Pub. No.: US 2012/0062741 A1
(43) Pub. Date: Mar. 15, 2012

(54) VEHICLE CAMERA SYSTEM

(75) Inventors: William E. Stimel, JR., Alexandria, OH (US); Keith A. Overton, Columbus, OH (US)

(73) Assignee: CVG MANAGEMENT CORPORATION, New Albany, OH (US)

(21) Appl. No.: 13/047,111

(22) Filed: Mar. 14, 2011

Related U.S. Application Data
(60) Provisional application No. 61/379,952, filed on Sep. 3, 2010.

(51) Int. Cl. H04N 7/18

(52) U.S. Cl. 348/148; 348/E07.085

(57) ABSTRACT

This innovation discloses the use of cameras in lieu of side-view minors on the outside of a truck cab. In operation, the images can be captured via aerodynamically positioned cameras and displayed upon monitors (e.g., LCD (liquid crystal display), LED (light emitting diode)) within the dash area of the driver. In one aspect, the monitors can be manually repositioned (or tilted) thereby effecting movement of the cameras. Other aspects can employ joysticks or buttons to move the camera positions. Yet other aspects include a peripheral view option. Still other aspects include a step light-up option. Still further, the camera assembly can include an object detection/warning system that notifies the driver of objects and other obstructions in the path of the truck. Moreover, video and/or images can be captured, for example for accident recovery or security scenarios.

### CROSS-REFERENCE TO RELATED APPLICATIONS

This application claims the benefit of U.S. Provisional Patent application Ser. No. 61/379,952 entitled “VEHICLE CAMERA SYSTEM” and filed Sep. 3, 2010. The entirety of the above-noted application is incorporated by reference herein.

### BACKGROUND

Today, many vehicles employ rear-view mirrors that are designed to enable an operator to see rearward, for example, to detect obstructions when in reverse as well as to see on-coming traffic from the rearward direction. The rear-view mirror enables an operator to view through a vehicle's rear window while continuing to face forward.

Most often, rear-view mirrors are used in conjunction with minors mounted externally to a vehicle, on one or both sides. These externally mounted mirrors are often referred to as “side-view” minors. In some scenarios, for example, upon trucks without a rear window, side-view minors are the only option available to view rearward.

Today, in addition to rear-view and side-view minors, many vehicles are being equipped with rear-view video cameras. One motivation of equipping passenger vehicles with rear-view cameras is to enable an operator to view directly behind the vehicle when in reverse. For example, many sport utility vehicles (SUVs) today have a profile such that it is not possible, or very difficult, to view directly behind the vehicle using minors. Thus, in an effort to reduce accidents and injuries/fatalities, rear-view cameras continue to emerge as an option on many vehicles.

Unfortunately, in most cases, images from today's camera systems are only available when the vehicle is in reverse. In other words, today's vehicle camera systems are merely a supplement to conventional rear-view and side-view minors, so as to enable an operator to see the “blind spot” directly behind a vehicle.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a vehicle camera system that is capable of providing a variety of views as well as other features, functions and benefits. For example, in addition to rearview, the innovation enables periphery and forward views as desired or appropriate. Object detection and notification can be provided in aspects.

Still further, in addition to a display of live video, the camera system is capable of recording still images or motion picture video. The recorded images or motion picture video can be used, for example, to provide security detection, theft recovery, accident reconstruction, operator evaluation, operator training, among others.

In yet other aspects, the innovation can employ touch screens or tilt-able displays that can dynamically adjust camera view/perspective. For instance, a user can tilt a display so as to pan in/out a camera view. As well, “pinch” to expand/reduce techniques can be employed to zoom in/out as desired. Still further, touchscreens with navigation controls can be employed to change direction and/or perspective of the cameras.

Moreover, other aspects can include illumination devices that can light up a desired area (e.g., step, door lock, cab proximity) so as to enhance safety and security. In other aspects, the illumination feature can be used (e.g., via switch or motion sensors) to light up an object for detection by the camera (e.g., when night-vision cameras are not used).

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example block diagram of an example vehicle monitoring system in accordance with aspects of the innovation.

FIG. 2 illustrates an example flow chart of procedures that capture images in accordance with an aspect of the innovation.

FIG. 3 illustrates an example rear-view camera system in accordance with aspects of the innovation.

FIG. 4 illustrates an example periphery view camera system in accordance with aspects of the innovation.

FIG. 5 illustrates an example camera-based illumination in accordance with aspects of the innovation.

FIG. 6 illustrates an example camera-based system in accordance with aspects of the innovation.

FIG. 7 illustrates an example camera bezel in accordance with aspects of the innovation.

FIGS. 8A-C illustrate an example camera bezel in accordance with aspects of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

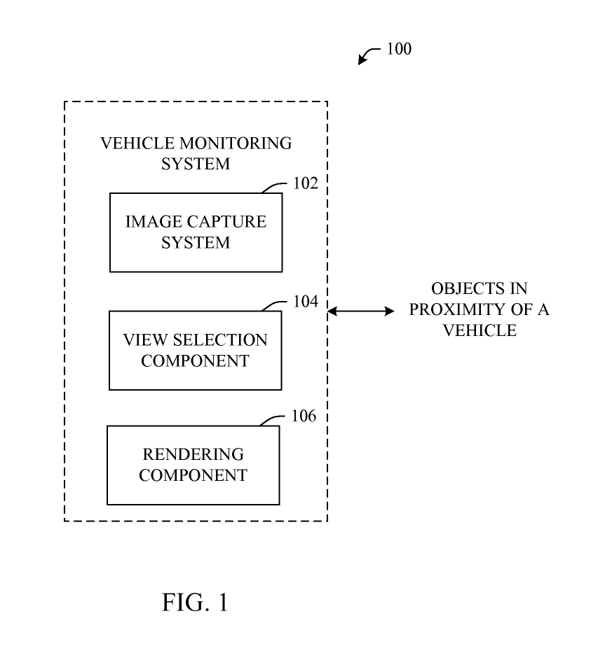

Referring initially to the drawings, FIG. 1 illustrates an example block diagram of a vehicle monitoring system 100 in accordance with aspects of the innovation. As shown, the vehicle monitoring system 100 can include an image capture system 102 and a view selection component 104. Essentially, the vehicle monitoring system 100 offers a host of features, functions and benefits beyond capabilities of conventional rear-view camera systems.

The image capture system 102 can include an image capture device (e.g., camera) capable of capturing images from a variety of perspectives. It will be appreciated that the innovation can employ most any image capture technology including, but not limited to, day- or night-vision capable optics systems. Additionally, the system 100 can employ still and full-motion video image capture as appropriate. In aspects, the images can be streamed or displayed in real- or near real-time. In other aspects, images (still or motion) can be captured and stored in a memory device.

A view selection component 104 can be employed to adjust the range of view of each image capture device. It will be appreciated that the system 100 can include most any number of image capture systems as desired and/or appropriate. For example, in one scenario, cameras can be mounted on either side of a truck's cab, in place of conventional side-view minors. These cameras can be manufactured in an aerodynamic fashion so as to reduce wind drag thereby enhancing fuel efficiency. In another example system, an additional camera(s) can be mounted upon the rear of the trailer (or tractor) so as to provide direct rearward view.

Still further, image capture devices (e.g., cameras) can be mounted in the grill area, visor location, etc. so as to enhance an operator's view of the surroundings. It is to be appreciated that most any mounting location and perspective view is to be included within the scope of this disclosure and claims appended hereto.

Continuing with the side-mounted aspect, the view selection component 104 can adjust the camera(s) for rearward view along the sides of the truck. This view perspective can be similar to that of a conventional side-view minor. However, the image capture technology of the camera(s) can enable enhanced features such as zoom in/out, motion sensor/notification, night vision, still and motion picture capture, periphery view, etc. It will be appreciated that the view selection component 104 (and associated controllers) in conjunction with the image capture system 102 can provide a wide range of features, functions and benefits above that of conventional side-view mirrors as well as conventional rear-view only camera systems.

Additionally, a rendering component 106 can be employed to render the images from the image capture system 102. In aspects, the rendering system 106 can employ one or more displays strategically mounted within the truck's cab. The displays can be most any type of displays, including but not limited to, an LED (light emitting diode) display and LCD (liquid crystal display). It will be appreciated that, if desired, the images can be visible in more than one location. For example, an operator view might be available upon a display cluster near the steering wheel. In other situations, the images may be visible in the sleeper area of the cab. In this scenario, it will be appreciated that the cameras can provide a security benefit such that an individual can monitor activity while the truck is parked.

In yet other aspects, a smartphone “app” or application can be provided and communicatively linked to the system (e.g., via Bluetooth, Internet, WiFi, etc.) so as to provide an operator or user ability to view the cameras from most any location. For instance, an operator can keep watch of their truck and trailer even while away, e.g., in a restaurant or other remote location. The mechanisms and components of providing an “app” with the aforementioned features, functions and benefits are all to be included within the scope of this disclosure and claims appended hereto.

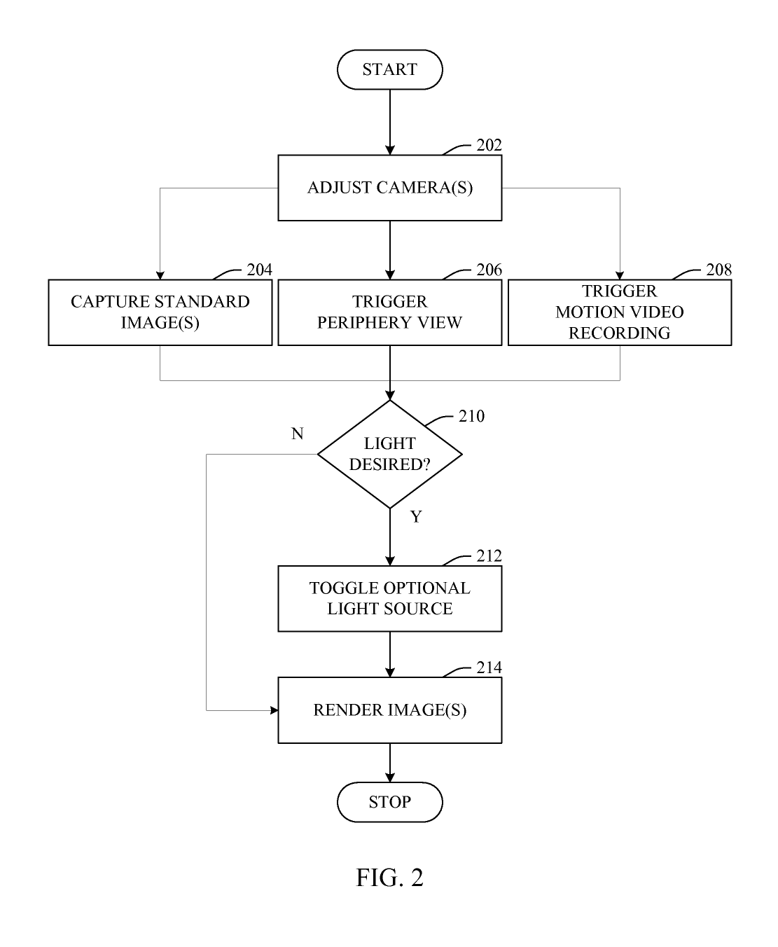

FIG. 2 illustrates a methodology of capturing and rendering images in accordance with aspects of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, cameras can be adjusted or otherwise positioned upon a vehicle. For example, cameras can be mounted in place of conventional side-view mirrors, upon the rear of a trailer, or most any other desired location. While much of this disclosure is directed to rear-facing cameras, it is to be understood that other aspects can employ forward-facing (individually or in combination with rear-facing) cameras without departing from the spirit and/or scope of the innovation.

In operation, the cameras can be adjusted by most any means, including but not limited to physical repositioning, voice activation, remote activation (e.g., cockpit located controls or switches, smartphone “apps,” etc.). Additionally, the cameras can be positioned automatically based upon motion or noise detection or the like.

In one aspect, at 204, the camera(s) can capture standard view images, either still or motion picture. In one somewhat standard embodiment, the cameras can capture images in perspective behind an operator. Here, the images can be still or motion picture video as appropriate or desired. Similarly, night-vision optics can be employed. Still further, in other aspects, sensors (motion or sound) can be employed to automatically illuminate an area as desired or appropriate.

In yet other aspects, motion sensors can be employed to automatically trigger image capture. For example, in aspects, the systems can automatically trigger via motion (and/or audio) detection such that image capture is started upon an object(s) coming within view. Still further, the system(s) can provide notification (audible, visual, haptic) upon object detection. Here, the system can alert a user of the presence of an image within the camera. For instance, an audible alert can sound, a smartphone can vibrate, etc.

At 206, periphery view can be triggered such that a wider (or differing scope) range of view is employed. In one aspect, the periphery view can enable an operator to view ground level (around the base of the vehicle) for obstructions or bystanders. It will be appreciated that it is not uncommon for animals, bottles, toys or even children to be present on or around the base of a truck (out of normal view of an operator). The periphery view option can increase (and/or redirect) the view angle of the camera(s) mounted on a truck. Aspects of this option will be better understood upon a review of the figures that follow.

At 208, motion picture video can be captured. For instance, motion picture video can be captured for a variety of reasons including but, not limited to, security, collision/accident reconstruction, driver performance evaluations, driver training, etc. As described supra, image, motion and/or sound detection sensors can be incorporated so as to trigger motion picture capture and retention upon detection of an object(s) in view.

In most all scenarios, a decision can be made if a light is desired or should be illuminated. At 210, this determination can be made, for example, to enhance image capture. In other aspects, the light option can be employed for added security and/or convenience of a user or operator and need not be associated with actual image capture. For instance, an LED or other light source can be incorporated into the camera system such that a light can be employed to illuminate a door lock, step, etc. At 212, if a light is desired, it can be toggled on/off as appropriate. In other aspects, light sensors and/or timers can be employed to trigger illumination as needed or desired.

At 214, images can be rendered for user display. For instance, at 214, images can be displayed upon one or more screens (e.g., LED display, LCD). In aspects, the screens themselves can be used to adjust the view of the camera(s). For example, a user can manually adjust the face (or monitor) of the display so as to effect remote-adjustment of the camera(s). Additionally, pinch to expand/reduce techniques can be used to zoom in/out as desired. For example, a user can use two fingers to quickly and easily pinch or expand an image or perspective as desired. Similarly, touchscreen controls can be used to pan or move perspective of the camera view as appropriate or desired.

In other aspects, touch screen displays can be employed to enable camera adjustment without physical movement of the screen(s). In yet other aspects, in addition to physical camera adjustment, most any switches, joysticks, etc. can be employed to adjust the camera(s) as appropriate or desired. Still further, images can be projected or rendered upon a smartphone or other communication-equipped portable device. Similarly, the cameras can be adjusted via the same devices in aspects as appropriate.

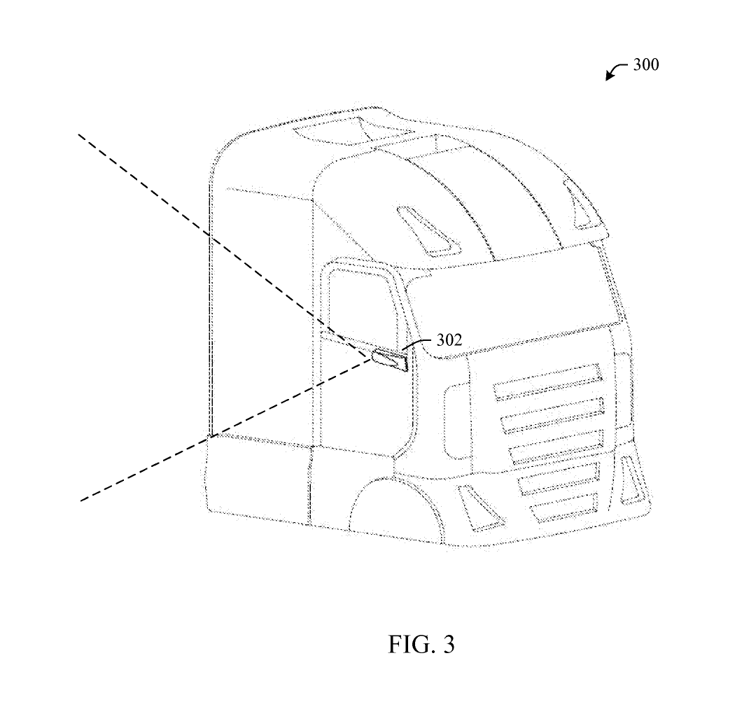

The following figures (FIGS. 3 to 5) illustrate example aspects of the innovation. While specific ranges of view are shown, it is to be understood that these examples are included to provide context or perspective to the innovation and not intended to limit the scope of the features, functions and/or benefits in any manner. Rather, alternative aspects are contemplated and are to be included within the scope of the features, functions and benefits of this specification.

Referring first to FIG. 3, an example camera system 300 is shown in accordance with aspects of the innovation. As shown by the dashed lines, in this example, the field of view can be in a rearward direction so as to enable an operator to see behind the cab on one or both sides.

As described herein, images captured via example camera 302 can be viewed in real- or near real-time as desired. In other aspects, still images can be captured and displayed. The display can be rendered upon local monitors, smartphones, or remote locations as desired or appropriate. In addition to live streaming, as described supra, images (and/or audio) can be captured and stored on a local (or remote) memory source.

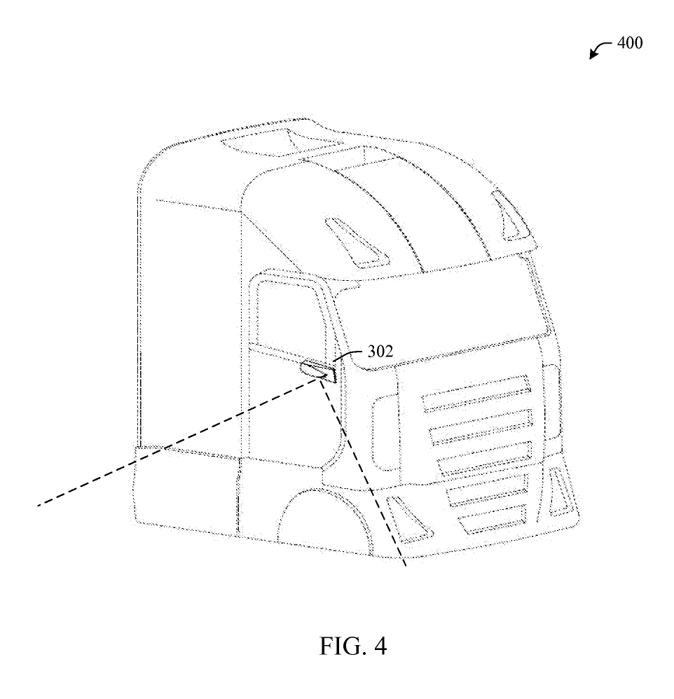

FIG. 4 is illustrative of an example periphery view system 400 such that the camera can be toggled (or switched) to view in a downward direction. This particular view can enable an operator to view objects at or near ground level (e.g., near the wheels of the truck). Still further, object detection sensors can be used in this and other scenarios so as to alert an operator of a potential obstruction.

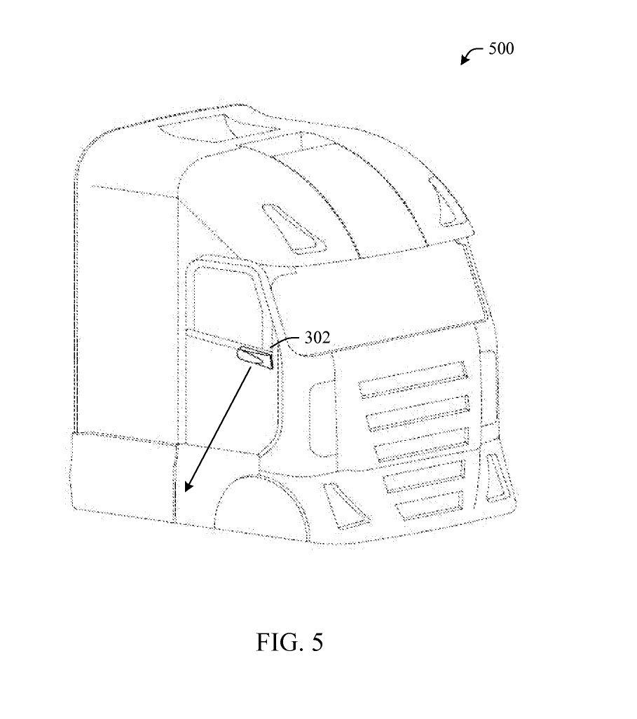

Turning now to FIG. 5, an example illumination system 500 is illustrated in accordance with aspects. While, as described supra, illumination can be employed in conjunction with the camera(s) 302 to enhance image capture, aspects can employ illumination so as to enhance comfort and/or safety of a user. In the example of FIG. 5, illumination can be employed to light a step area so as to help a user visualize the step in low light scenarios. In other aspects, the light can be used to illuminate an area proximate to the truck thereby providing security in low light situations. These and other uses of the illumination are to be included within the scope of this disclosure and claims appended hereto.

As described above, the illumination can employ LEDs, or other light sources as appropriate. Additionally, the illumination can be aimed or directed in most any direction, e.g., in a direction of detected motion or sound. As well, the illumination source can be turned on/off manually or automatically, e.g., triggered based upon noise or motion detection.

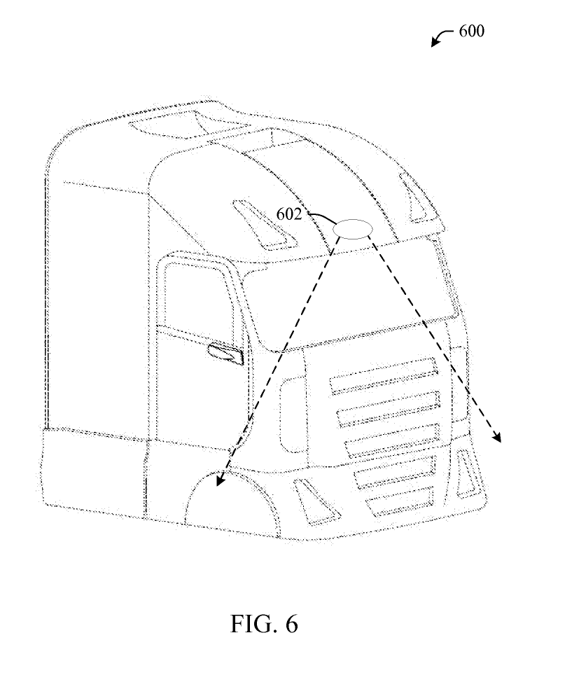

With reference now to FIG. 6, in addition to the side positioned cameras (that can replace conventional minors), an example long haul truck 600 is shown having a “view down” camera 602 mounted on the roof portion of the cab. As shown, the camera can be mounted substantially in the center, above the windshield. This vantage point enables the camera 602 to view down the rake of the windshield and front grille, for example, to see in conventional “blind spots.” It will be appreciated that many truck bodies, especially cab-over-engine (COE) cabs, make it difficult to see downward, e.g., along the front bumper. An example front mounted camera as shown in FIG. 6 can alleviate this issue. While a specific mounting location is shown in FIG. 6, it is to be understood and appreciated that most any mounting location can be employed that enables a sufficient view perspective as desired. Additionally, while a single camera is shown, other aspects can employ two or more cameras as appropriate.

Similar to the front mounted camera 602 of FIG. 6, aspects can employ a rear mounted camera (not shown). These rear mounted cameras can be mounted upon the back of the cab and/or trailer so as to effect visualization in a directly (or substantially directly) rearward direction. In one aspect, a rearward camera mounted upon the back of the cab can be used for trailer hookup among other uses.

It is to be understood that, if desired, wireless (e.g., Bluetooth) cameras can be employed in the aspects described herein. For example, wireless cameras can enable an operator to easily reposition a camera based upon a specific need, e.g., with or without a trailer.

As mentioned supra, in still other aspects, it is to be appreciated that audio (e.g., microphones) can be built into the camera/visual system described herein. In one aspect, the audio can be filterable, for example, based upon frequency of sounds, etc.

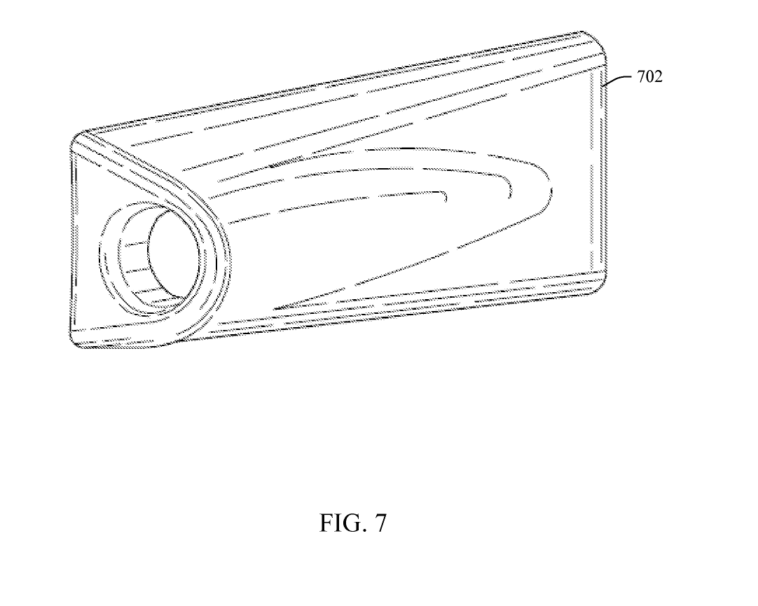

Referring now to FIG. 7, an example aerodynamic camera bezel 702 is shown. As illustrated in FIG. 3, this camera bezel 702 can be fixedly mounted along the side of a long haul truck, for example, in place of conventional side-view minors. The bezel can house most any type or kind of image capture device capable of capturing images based upon desired functionality. For example, a camera capable of night vision can be used as appropriate or desired.

The bezel housing 702 can be manufactured of most any plastic, composite, metal or other suitably rigid material. For example, the bezel 702 can be injection molded in a single or multiple piece design. While a specific bezel 702 is illustrated, it is to be understood and appreciated that alternative shapes and designs can be utilized without departing from the features, functions and benefits of the innovation.

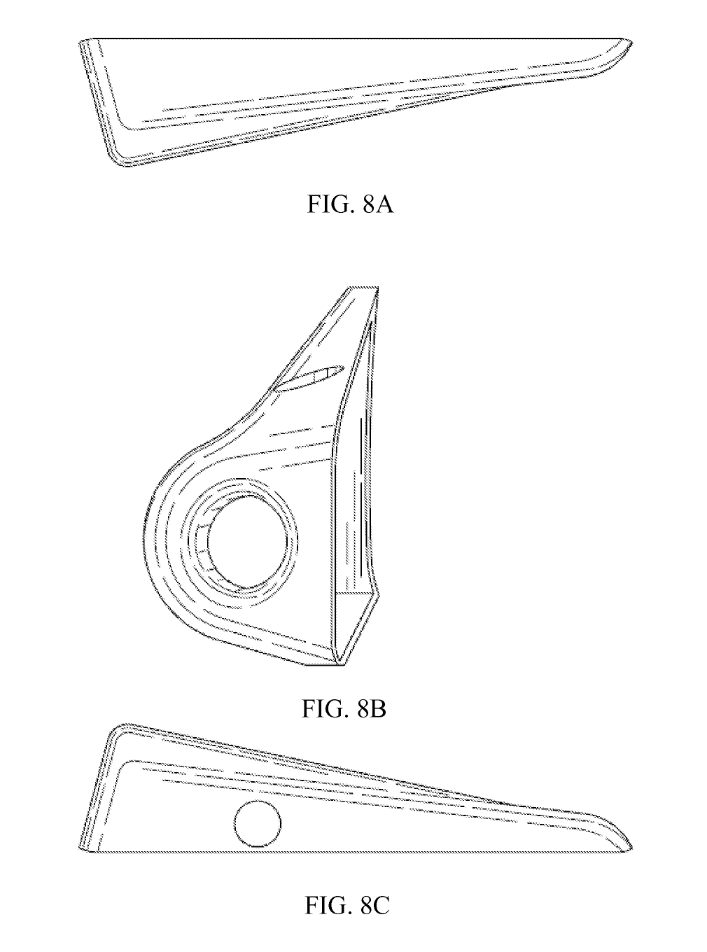

FIGS. 8A-8C illustrate alternative views of the bezel 702. In particular, FIG. 8A is a top down perspective view of the bezel 702. As will be appreciated, the overall shape of the bezel 702 can enhance aerodynamic effect thereby reducing wind drag upon the camera housing.

FIGS. 8B and 8C include a front view and bottom up view respectively. As seen in FIG. 8B, the circular cutout can provide access for a camera lens. The bottom view includes a circular cutout that can be used for an illumination source such as a LED or other appropriate light source as described herein.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates image capture, comprising:
an aerodynamic image capture system disposed upon a vehicle, wherein the image capture system includes one or more camera devices; and
a view selection component that facilitates selection of a plurality of view perspectives based in part upon a user preference.

2. The system of claim 1, the plurality of view perspectives includes a rearward view and a periphery view.

3. The system of claim 1, further comprising a motion detection system that triggers image capture upon detection of a moving object.

4. The system of claim 3, further comprising a notification system that alerts of detection of the moving object.

5. The system of claim 1, wherein the image capture system stores video for at least one of security, accident reconstruction, driver evaluation or driver training.

6. The system of claim 1, further comprising a rendering component that includes one or more displays, wherein each of the one or more displays facilitates adjustment of view area of each of the one or more camera devices.

7. The system of claim 1, further comprising a light source that illuminates an area desired by a user or as a function of a field of view, wherein the light source is embodied within the one or more camera devices.

8. The system of claim 1, wherein the view selection component communicates with one of a smartphone or portable device that renders associated images for a user to visualize.

9. The system of claim 1, further comprising an audio device the enables a capture of audio that corresponds to video collected via the one or more cameras.

10. The system of claim 1, further comprising a rendering component that displays one or more images captured via the one or more cameras.

11. The system of claim 10, wherein the rendering component facilities adjustment of a subset of the one or more cameras.

12. The system of claim 11, wherein the rendering component enables pinching to adjust a zoom characteristic of a view.

13. The system of claim 12, wherein the rendering component is embodied within a smartphone.

14. The system of claim 1, further comprising an illumination system that facilitates illumination of an area for image detection.

15. A method of capturing images, comprising:
adjusting a camera mounted to a vehicle;
selecting a viewing area;
capturing one or more images via the camera; and
rendering the one or more images via a display device.

16. The method of claim 15, wherein the images are still images or motion picture video.

17. The method of claim 15, wherein the act of adjusting includes manipulating a touch sensitive display screen.

18. The method of claim 17, further comprising trigging the capture of the one or more images via motion detection means.

19. A vehicle camera system, comprising:
means for adjusting a camera as a function of direction or viewing area;
means for detecting motion in proximity of the camera;
means for trigging the capture of motion video via the camera upon detection of motion;
means for capturing audio that corresponds to the motion video; and
means for rendering the captured motion video and corresponding audio.

20. The system of claim 19 further comprises means for illuminating an area for one of security or image detection.
